(19) United States
(12) Patent Application Publication
(10) Pub. No.: US 2025/0380285 A1
(43) Pub. Date: Dec. 11, 2025

(54) COMPRESSION LEVEL BASED ON NONLINEARITY CAPABILITY

(71) Applicant: QUALCOMM Incorporated, San Diego, CA (US)

(72) Inventors: Aviv REGEV, Tel Aviv (IL); Ronen SHAKED, Kfar Saba (IL); Amit MOSES, Tel Aviv (IL)

(21) Appl. No.: 18/735,563

(22) Filed: Jun. 6, 2024

(51) Int. Cl. H04W 72/51

(52) U.S. Cl. CPC H04W 72/51

(57) ABSTRACT

Various aspects of the present disclosure generally relate to wireless communication. In some aspects, a user equipment (UE) may transmit nonlinearity (NL) cancellation capability information associated with the UE. The UE may receive a request to indicate a quantity of parameters to estimate per power amplifier (PA) and a quantity of receive antennas. The UE may transmit a report that indicates the quantity of parameters and the quantity of receive antennas. Numerous other aspects are described.

### FIELD OF THE DISCLOSURE

Aspects of the present disclosure generally relate to wireless communication and specifically relate to techniques, apparatuses, and methods for determining a compression level based on a nonlinearity capability.

### BACKGROUND

Wireless communication systems are widely deployed to provide various services that may include carrying voice, text, messaging, video, data, and/or other traffic. The services may include unicast, multicast, and/or broadcast services, among other aspects. Typical wireless communication systems may employ multiple-access radio access technologies (RATs) capable of supporting communication with multiple users by sharing available system resources (in some aspects, time domain resources, frequency domain resources, spatial domain resources, and/or device transmit power, among other aspects). Aspects of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An aspect telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (e.g., cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other aspects. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting nonlinearity (NL) cancellation capability information associated with the UE. The method may include receiving a request to indicate a quantity of parameters to estimate per power amplifier (PA) and a quantity of receive antennas. The method may include transmitting a report that indicates the quantity of parameters and the quantity of receive antennas.

Some aspects described herein relate to a method of wireless communication performed by a network entity. The method may include receiving NL cancellation capability information associated with a UE. The method may include transmitting, based at least in part on the NL cancellation capability information, a request to indicate a quantity of parameters to estimate per PA and a quantity of receive antennas. The method may include receiving a report that indicates the quantity of parameters and the quantity of receive antennas.

Some aspects described herein relate to an apparatus for wireless communication at a UE. The apparatus may include one or more memories and one or more processors coupled to the one or more memories. The one or more processors may be individually or collectively configured to transmit NL cancellation capability information associated with the UE. The one or more processors may be individually or collectively configured to receive a request to indicate a quantity of parameters to estimate per PA and a quantity of receive antennas. The one or more processors may be individually or collectively configured to transmit a report that indicates the quantity of parameters and the quantity of receive antennas.

Some aspects described herein relate to an apparatus for wireless communication at a network entity. The apparatus may include one or more memories and one or more processors coupled to the one or more memories. The one or more processors may be individually or collectively configured to receive NL cancellation capability information associated with a UE. The one or more processors may be individually or collectively configured to transmit, based at least in part on the NL cancellation capability information, a request to indicate a quantity of parameters to estimate per PA and a quantity of receive antennas. The one or more processors may be individually or collectively configured to receive a report that indicates the quantity of parameters and the quantity of receive antennas.

Some aspects described herein relate to a non-transitory computer-readable medium that stores a set of instructions for wireless communication by a UE. The set of instructions, when executed by one or more processors of the UE, may cause the UE to transmit NL cancellation capability information associated with the UE. The set of instructions, when executed by one or more processors of the UE, may cause the UE to receive a request to indicate a quantity of parameters to estimate per PA and a quantity of receive antennas. The set of instructions, when executed by one or more processors of the UE, may cause the UE to transmit a report that indicates the quantity of parameters and the quantity of receive antennas.

Some aspects described herein relate to a non-transitory computer-readable medium that stores a set of instructions for wireless communication by a network entity. The set of instructions, when executed by one or more processors of the network entity, may cause the network entity to receive NL cancellation capability information associated with a UE. The set of instructions, when executed by one or more processors of the network entity, may cause the network entity to transmit, based at least in part on the NL cancellation capability information, a request to indicate a quantity of parameters to estimate per PA and a quantity of receive antennas. The set of instructions, when executed by one or more processors of the network entity, may cause the network entity to receive a report that indicates the quantity of parameters and the quantity of receive antennas.

Some aspects described herein relate to an apparatus for wireless

communication. The apparatus may include means for transmitting NL cancellation capability information associated with the apparatus. The apparatus may include means for receiving a request to indicate a quantity of parameters to estimate per PA and a quantity of receive antennas. The apparatus may include means for transmitting a report that indicates the quantity of parameters and the quantity of receive antennas.

Some aspects described herein relate to an apparatus for wireless communication. The apparatus may include means for receiving NL cancellation capability information associated with another apparatus. The apparatus may include means for transmitting, based at least in part on the NL cancellation capability information, a request to indicate a quantity of parameters to estimate per PA and a quantity of receive antennas. The apparatus may include means for receiving a report that indicates the quantity of parameters and the quantity of receive antennas.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating using nonlinear (NL) distortion, in accordance with the present disclosure.

FIG. 5 is a diagram illustrating an example of NL distortion, in accordance with the present disclosure.

FIG. 6 is a diagram illustrating an example associated with canceling NL distortion, in accordance with the present disclosure.

FIG. 7 is a diagram illustrating an example of backoff versus equation to parameters ratio (EPR), in accordance with the present disclosure.

FIG. 8 is a diagram illustrating an example process performed, in some aspects, at a UE or an apparatus of a UE, in accordance with the present disclosure.

FIG. 9 is a diagram illustrating an example process performed, in some aspects, at a network entity or an apparatus of a network entity, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. In some aspects, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Nonlinear (NL) distortions occur when a power amplifier (PA) of a transmitter fails to reproduce the output waveform as the exact amplified replica of the input waveform. In such cases, the nonlinearity of the amplifier results in distortions in the amplitude, frequency, and phase of the output waveform. NL distortion results from systems where the output signal is not exactly proportional to the input signal and harmonics or intermodulation products are generated.

To reduce NL distortions, power output backoff (boOut) may be used to reduce a transmission power used to transmit the communication. However, an increase in boOut may cause a reduction in power amplifier efficiency (PAE). The reduction of PAE may correspond to a reduction of power transmitted on the channel and an increase in energy dissipated as heat. A user equipment (UE) may estimate NL distortion of the signal to correct a received signal for the NL distortion. This may include digital post- distortion (DPOD) correction.

Eliminating PA NL distortion provides two significant benefits to the

communication: signal-to-noise ratio (SNR) improvement and power conservation. The PA of the transmitter may increase the transmission power, even beyond the linear region of its PA (work at an operating point at its NL region), without NL distortion that limits the SNR. Thus, the SNR will improve (increase) due to the higher transmission power. The transmitter may reduce its PA power supply voltage. Reducing the PA power supply voltage increases the NL region (NL distortion starts from a lower transmission power). However, this concern is addressed with the cancellation of the NL distortion. Due to the cancellation, the PA may work with a lower power supply voltage and conserve power, without entering the NL region.

Advanced handling of the NL distortion may involve estimating and canceling the NL influence to eliminate the NL impairment limitation. With the aid of the cancellation, a network entity (e.g., gNB) can work at an operation point in the NL region without the concern of having an NL limiting noise floor. However, the NL cancellation benefits come at the expense of greatly increasing the complexity and the overall latency of the data decoding process at the UE. In fact, the demanded complexity and latency increases as the NL distortion becomes more severe, which occurs as the transmission power increases and the power supply voltage decreases. Hence, the amount that the transmission power increases and the power supply voltage decreases may depend on the UE's power consumption capability and the downlink (DL) latency limitations.

Various aspects relate generally to addressing NL distortion. Some aspects more specifically relate to a UE indicating its NL cancellation complexity capabilities and latency limitations, to aid a network entity (e.g., gNB) in determining an optimum transmission power. The optimum transmission power may be based at least in part on the UE's NL cancellation capabilities. The UE may indicate the quantity K of NL model parameters that the UE can estimate in each NL estimation, according to the UE's hardware complexity limitation and the DL latency. In some aspects, K may be the quantity of basis functions of an assumed NL model. In some aspects, K may be the quantity of different power degrees at a PA polynomial model. In some aspects, K may be the quantity of components at a neural network associated with estimating the PA model. That is, K may indicate the quantity of parameters that are to be estimated regardless of the chosen NL cancellation method. The NL cancellation method is not limited to a specific algorithm and may involve the algorithm's quantity of degrees of freedom. In some aspects, the UE may indicate a quantity Nᵣₓ of receive antennas.

Particular aspects of the subject matter described in this disclosure can be implemented to realize one or more of the following potential advantages. By indicating its NL cancellation capability, the UE may help the network entity to use the correct transmit power to improve communications. Improving communications increases throughput and decreases latency.

Multiple-access radio access technologies (RATs) have been adopted in various telecommunication standards to provide common protocols that enable wireless communication devices to communicate on a municipal, enterprise, national, regional, or global level. In some aspects, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other aspects. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other aspects. The methods, operations, apparatuses, and techniques described herein may enable one or more of the foregoing technologies and/or support one or more of the foregoing use cases.

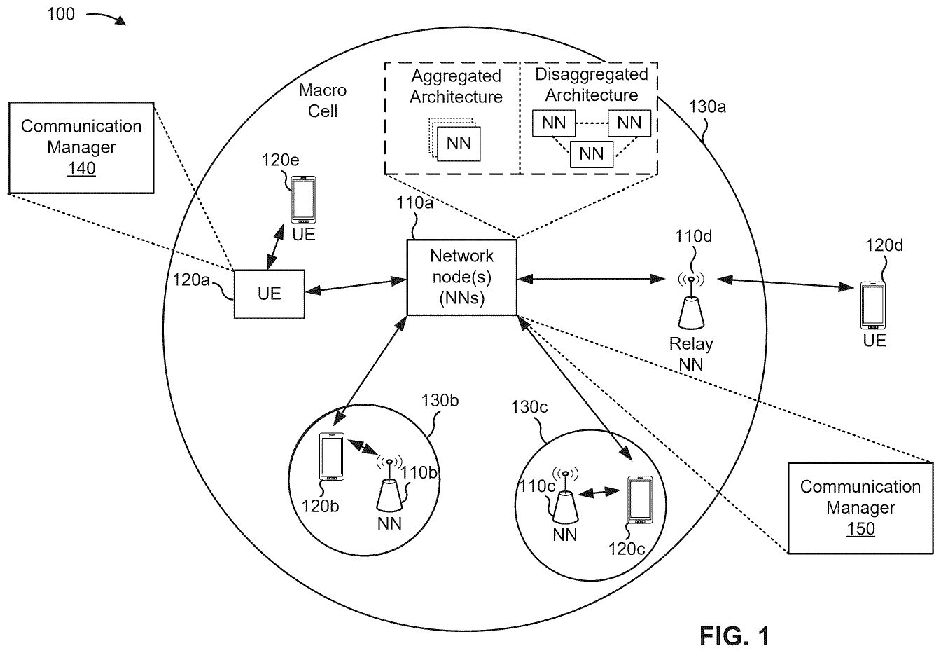

FIG. 1 is a diagram illustrating an aspect of a wireless communication network 100, in accordance with the present disclosure. The wireless communication network 100 may be or may include elements of a 5G (or NR) network or a 6G network, among other aspects. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. In some aspects, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other aspects. In some aspects, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. In some aspects, each of FR4a, FR4-1, FR4, and FR5 falls within the EHF band. In some aspects, the wireless communication network 100 may implement dynamic spectrum sharing (DSS), in which multiple RATs (e.g., 4G/Long Term Evolution (LTE) and 5G/NR) are implemented with dynamic bandwidth allocation (e.g., based on user demand) in a single frequency band. It is contemplated that the frequencies included in these operating bands (e.g., FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (e.g., a single physical structure) or may be implemented as two or more physical nodes (e.g., two or more distinct physical structures). In some aspects, a network node 110 may be a device or system that implements part of a radio protocol stack, a device or system that implements a full radio protocol stack (such as a full gNB protocol stack), or a collection of devices or systems that collectively implement the full radio protocol stack. In some aspects, and as shown, a network node 110 may be an aggregated network node (having an aggregated architecture), meaning that the network node 110 may implement a full radio protocol stack that is physically and logically integrated within a single node (e.g., a single physical structure) in the wireless communication network 100. In some aspects, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. In some aspects, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other aspects. A DU may host one or more of a radio link control (RLC) layer, a medium access control (MAC) layer, and/or one or more higher physical (PHY) layers depending, at least in part, on a functional split, such as a functional split defined by the 3GPP. In some aspects, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other aspects. An RU may host RF processing functions or lower PHY layer functions, such as an FFT, an iFFT, beamforming, or PRACH extraction and filtering, in some aspects, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some aspects, a CU, a DU, and/or an RU may be implemented as a virtual unit, such as a virtual central unit (VCU), a virtual distributed unit (VDU), or a virtual radio unit (VRU), among other aspects. A virtual unit may be implemented as a virtual network function, such as associated with a cloud deployment.

Some network nodes 110 (e.g., a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (e.g., three) cells. In some aspects, a network node 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some aspects, a cell may not necessarily be stationary. In some aspects, the geographic area of the cell may move according to the location of an associated mobile network node 110 (e.g., a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other aspects. In the aspect shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. In some aspects, macro network nodes may have a high transmit power level (e.g., 5 to 40 watts), whereas pico network nodes, femto network nodes, and relay network nodes may have lower transmit power levels (e.g., 0.1 to 2 watts).

In some aspects, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (e.g., scheduling information, reference signals, and/or configuration information) from a network node 110 to a UE 120. A downlink data channel may be used to transmit downlink data (e.g., user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (e.g., reference signals and/or feedback corresponding to one or more downlink transmissions) from a UE 120 to a network node 110. An uplink data channel may be used to transmit uplink data (e.g., user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (e.g., a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (e.g., by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower- capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. In some aspects, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some aspects, network resources for wireless communication (such as time resources, frequency resources, and/or spatial resources) may be shared between access links and backhaul links.

In some aspects, any network node 110 that relays communications may be referred to as a relay network node, a relay station, or simply as a relay. A relay may receive a transmission of a communication from an upstream station (e.g., another network node 110 or a UE 120) and transmit the communication to a downstream station (e.g., a UE 120 or another network node 110). In this case, the wireless communication network 100 may include or be referred to as a “multi-hop network.” In the example shown in FIG. 1, the network node 110d (e.g., a relay network node) may communicate with the network node 110a (e.g., a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other aspects.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, and/or smart jewelry, such as a smart ring or a smart bracelet), an entertainment device (e.g., a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (e.g., operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some aspects, one or more of the processors may be preconfigured to perform various functions or operations described herein without requiring configuration by software. The processing system may further include or be coupled with one or more modems (such as a Wi-Fi (e.g., Institute of Electrical and Electronics Engineers (IEEE) compliant) modem or a cellular (e.g., 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other aspects. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other aspects. A third category of UEs 120 may have mid-tier complexity and/or capability (e.g., a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other aspects. RedCap UEs may bridge a gap between the capability and complexity of NB-IOT devices and/or eMTC UEs, and mission-critical IoT devices and/or premium UEs. RedCap UEs may include wearable devices, IoT devices, industrial sensors, and/or cameras that are associated with a limited bandwidth, power capacity, and/or transmission range, among other aspects. RedCap UEs may support healthcare environments, building automation, electrical distribution, process automation, transport and logistics, and/or smart city deployments, among other aspects.

In some aspects, two or more UEs 120 (e.g., shown as UE 120a and UE 120c) may communicate directly with one another using sidelink communications (e.g., without communicating by way of a network node 110 as an intermediary). As an aspect, the UE 120a may directly transmit data, control information, or other signaling as a sidelink communication to the UE 120e. This is in contrast to, in some aspects, the UE 120a first transmitting data in an UL communication to a network node 110, which then transmits the data to the UE 120e in a DL communication. In various aspects, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various aspects, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (e.g., in the same time resources). By operating in a full-duplex mode, network nodes 110 and/or UEs 120 may generally increase the capacity of the network and the radio access link. In some aspects, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some aspects, full-duplex operation may be enabled for a UE 120 but not for a network node 110. In some aspects, a UE 120 may simultaneously transmit an UL transmission to a first network node 110 and receive a DL transmission from a second network node 110 in the same time resources. In some other aspects, full-duplex operation may be enabled for a network node 110 but not for a UE 120. In some aspects, a network node 110 may simultaneously transmit a DL transmission to a first UE 120 and receive an UL transmission from a second UE 120 in the same time resources. In some other aspects, full-duplex operation may be enabled for both a network node 110 and a UE 120.

In some aspects, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some aspects, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NCJT).

In some aspects, a UE (e.g. a UE 120) may include a communication manager 140. As described in more detail elsewhere herein, the communication manager 140 may transmit NL cancellation capability information associated with the UE. The communication manager 140 may receive a request to indicate a quantity of parameters to estimate per PA and a quantity of receive antennas. The communication manager 140 may transmit a report that indicates the quantity of parameters and the quantity of receive antennas. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive NL cancellation capability information associated with a UE. The communication manager 150 may transmit, based at least in part on the NL cancellation capability information, a request to indicate a quantity of parameters to estimate per PA and a quantity of receive antennas. The communication manager 150 may receive a report that indicates the quantity of parameters and the quantity of receive antennas. Additionally, or alternatively, the communication manager 150 may perform one or more other operations described herein.

As indicated above, FIG. 1 is provided as an example. Other examples may differ from what is described with regard to FIG. 1.

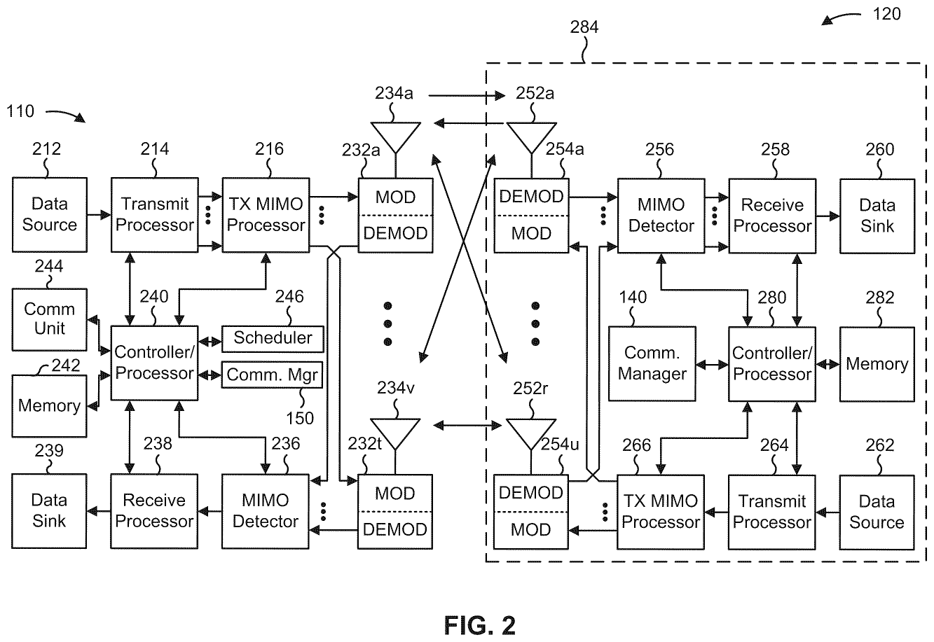

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other aspects. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. In some aspects, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. In some aspects, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. In some aspects, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some aspects, the transmit processor 214 may select one or more MCSs for the UE 120 in accordance with one or more channel quality indicators (CQIs) received from the UE 120. The network node 110 may process the data (e.g., including encoding the data) for transmission to the UE 120 on a downlink in accordance with the MCS(s) selected for the UE 120 to generate data symbols. The transmit processor 214 may process system information (e.g., semi-static resource partitioning information (SRPI)) and/or control information (e.g., CQI requests, grants, and/or upper layer signaling) and provide overhead symbols and/or control symbols. The transmit processor 214 may generate reference symbols for reference signals (e.g., a cell-specific reference signal (CRS), a demodulation reference signal (DMRS), or a channel state information (CSI) reference signal (CSI-RS)) and/or synchronization signals (e.g., a primary synchronization signal (PSS) or a secondary synchronization signals (SSS)).

The TX MIMO processor 216 may perform spatial processing (e.g., precoding) on the data symbols, the control symbols, the overhead symbols, and/or the reference symbols, if applicable, and may provide a set of output symbol streams (e.g., T output symbol streams) to the set of modems 232. In some aspects, each output symbol stream may be provided to a respective modulator component (shown as MOD) of a modem 232. Each modem 232 may use the respective modulator component to process (e.g., to modulate) a respective output symbol stream (e.g., for orthogonal frequency division multiplexing (OFDM)) to obtain an output sample stream. Each modem 232 may further use the respective modulator component to process (e.g., convert to analog, amplify, filter, and/or upconvert) the output sample stream to obtain a time domain downlink signal. The modems 232a through 232t may together transmit a set of downlink signals (e.g., T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (e.g., from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (e.g., a demodulator component, shown as DEMOD, of a modem 232), may be detected by the MIMO detector 236 (e.g., a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some aspects, the scheduler 246 may allocate recurring time domain resources and/or frequency domain resources that the UE 120 may use to transmit and/or receive communications using an RRC configuration (e.g., a semi-static configuration), in some aspects, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some aspects, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other aspects. The network node 110 may use the communication unit 244 to transmit and/or receive data associated with the UE 120 or to perform network control signaling, among other aspects. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other aspects. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (e.g., R received signals) to the set of modems 254. In some aspects, each received signal may be provided to a respective demodulator component (shown as DEMOD) of a modem 254. Each modem 254 may use the respective demodulator component to condition (e.g., filter, amplify, downconvert, and/or digitize) a received signal to obtain input samples. Each modem 254 may use the respective demodulator component to further demodulate or process the input samples (e.g., for OFDM) to obtain received symbols. The MIMO detector 256 may obtain received symbols from the set of modems 254, may perform MIMO detection on the received symbols if applicable, and may provide detected symbols. The receive processor 258 may process (e.g., decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other aspects. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (e.g., for DFT-s-OFDM or CP-OFDM). The TX MIMO processor 266 may perform spatial processing (e.g., precoding) on the data symbols, the control symbols, the overhead symbols, and/or the reference symbols, if applicable, and may provide a set of output symbol streams (e.g., U output symbol streams) to the set of modems 254. In some aspects, each output symbol stream may be provided to a respective modulator component (shown as MOD) of a modem 254. Each modem 254 may use the respective modulator component to process (e.g., to modulate) a respective output symbol stream (e.g., for OFDM) to obtain an output sample stream. Each modem 254 may further use the respective modulator component to process (e.g., convert to analog, amplify, filter, and/or upconvert) the output sample stream to obtain an uplink signal.

The modems 254a through 254u may transmit a set of uplink signals (e.g., R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other aspects. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some aspects, each of the antenna elements of an antenna 234 or an antenna 252 may include one or more sub-elements for radiating or receiving radio frequency signals. In some aspects, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). In some aspects, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (e.g., an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. In some aspects, a UE 120 may include a single antenna element, two antenna elements, four antenna elements, eight antenna elements, or a different number of antenna elements. As another aspect, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. In some aspects, the functions described with respect to the transmit processor 264, the receive processor 258, and/or the TX MIMO processor 266 may be performed by or under the control of the controller/processor 280.

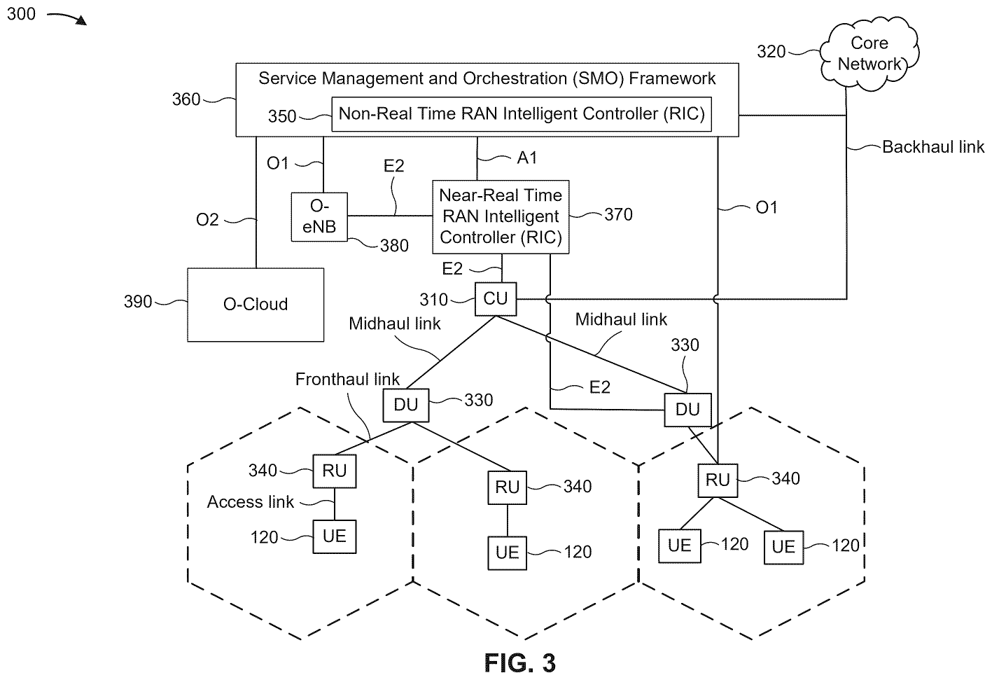

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (e.g., via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. In some aspects, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some aspects, the Non-RT RIC 350 or the Near-RT RIC 370 may tune RAN behavior or performance. In some aspects, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

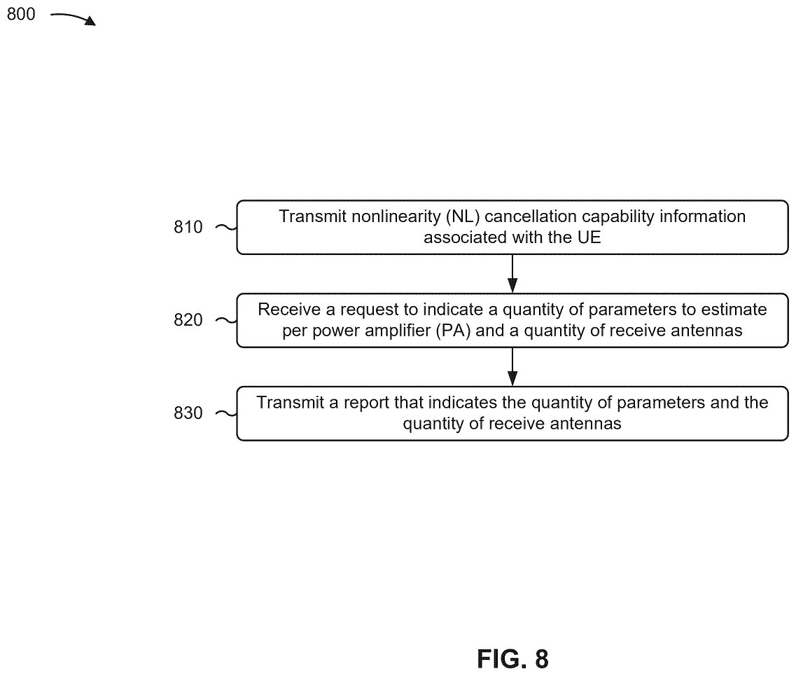

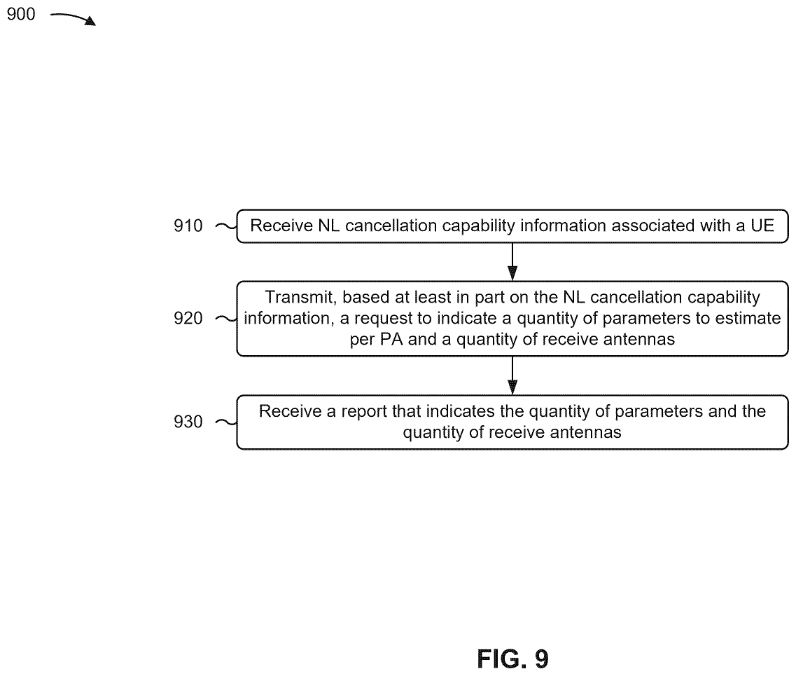

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with determining a compression level based on an NL cancellation capability, as described in more detail elsewhere herein. In some aspects, the controller/processor 240 of the network node 110, the controller/processor 280 of the UE 120, any other component(s) of FIG. 2, the CU 310, the DU 330, or the RU 340 may perform or direct operations of, in some aspects, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some aspects, the memory 242 or the memory 282 may include a non-transitory computer-readable medium storing a set of instructions (e.g., code or program code) for wireless communication. The memory 242 may include one or more memories, such as a single memory or multiple different memories (of the same type or of different types). The memory 282 may include one or more memories, such as a single memory or multiple different memories (of the same type or of different types). In some aspects, the set of instructions, when executed (e.g., directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some aspects, executing instructions may include running the instructions, converting the instructions, compiling the instructions, and/or interpreting the instructions, among other aspects.

In some aspects, the UE 120 includes means for transmitting NL cancellation capability information associated with the UE; means for receiving a request to indicate a quantity of parameters to estimate per PA and a quantity of receive antennas; and/or means for transmitting a report that indicates the quantity of parameters and the quantity of receive antennas. The means for the UE 120 to perform operations described herein may include, in some aspects, one or more of communication manager 140, antenna 252, modem 254, MIMO detector 256, receive processor 258, transmit processor 264, TX MIMO processor 266, controller/processor 280, or memory 282.

In some aspects, the network entity 110 includes means for receiving NL cancellation capability information associated with a UE; means for transmitting, based at least in part on the NL cancellation capability information, a request to indicate a quantity of parameters to estimate per PA and a quantity of receive antennas; and/or means for receiving a report that indicates the quantity of parameters and the quantity of receive antennas. In some aspects, the means for the network entity 110 to perform operations described herein may include, in some aspects, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an aspect. Other aspects may differ from what is described with regard to FIG. 3.

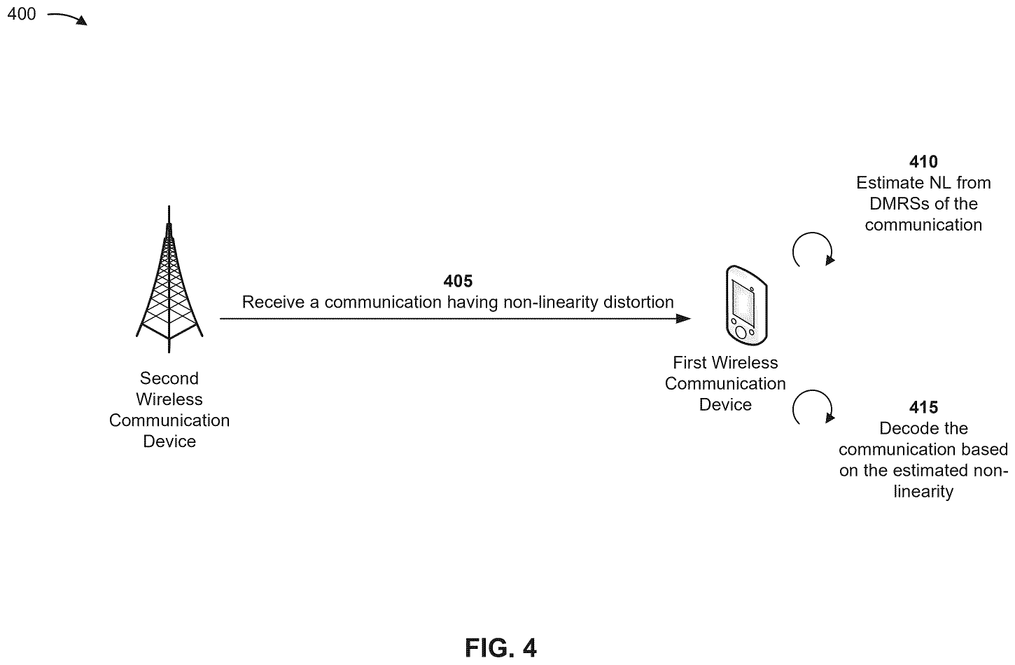

FIG. 4 is a diagram illustrating an aspect 400 of communicating using NL distortion, in accordance with the present disclosure. As shown in FIG. 4, a first wireless communication device (WCD) and a second WCD may communicate based on transmitting communications with NL distortion and attempting to decode communications with NL distortion. The first WCD may include or may be included in a UE (e.g., UE 120) or a network node (e.g., network node 110 or a repeater). The second WCD may include or may be included in a UE (e.g., UE 120) or a network node (e.g., network node 110 or a repeater).

As shown by reference number 405, the second WCD may transmit, and the first WCD may receive, a communication having NL distortion. The second WCD may transmit the communication having NL distortion based on the second WCD using non-linear components, such as high-power PAs with limited linear dynamic range (DR), and a polynomial response. The NL distortions may be classified as in-band distortion, which affects a link performance (e.g., an error vector magnitude (EVM)), and an out-band distortion, which corresponds to an amount of adjacent channel interference (ACI).

NL distortions occur when a PA fails to reproduce the output waveform as the exact amplified replica of the input waveform. In such cases, the nonlinearity of the amplifier results in distortions in the amplitude, frequency, and phase of the output waveform. NL distortion results from systems where the output signal is not exactly proportional to the input signal and harmonics or intermodulation products are generated.

To reduce NL distortions, boOut may be used to reduce a transmission power used to transmit the communication. However, an increase in boOut may cause a reduction in PAE. The reduction of PAE may correspond to a reduction of power transmitted on the channel and an increase in energy dissipated as heat.

As shown by reference number 410, the second WCD may estimate NL of the communication using DMRSs or other reference signals of the communication. In some aspects, the second node may use a sequence associated with the DMRSs to estimate NL distortion of the signal and to correct a received signal for the NL distortion. This may include DPOD correction. As shown by reference number 415, the second node may decode the communication based on the estimated NL of the communication.

As indicated above, FIG. 4 is provided as an example. Other examples may differ from what is described with regard to FIG. 4.

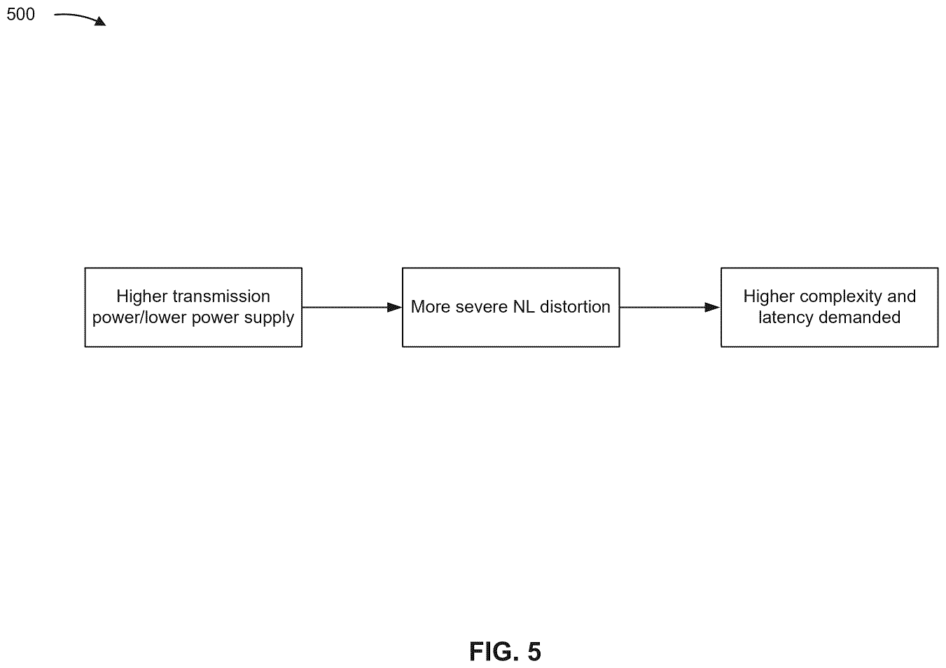

FIG. 5 is a diagram illustrating an example 500 of NL distortion, in accordance with the present disclosure.

Eliminating PA NL distortion provides two significant benefits to the communication: SNR improvement and power conservation. The PA of the transmitter may allow an increase in the transmission power, even beyond the linear region of its PA (work at an operating point at its NL region), without the concern of having an NL distortion that limits the SNR. Thus, the SNR will improve (increase) due to the higher transmission power. The transmitter can reduce its PA power supply voltage. Reducing the PA power supply voltage causes an increased NL region (the NL distortion effect occurs starting from a lower transmission power). However, this concern is addressed due to the cancellation of the NL distortion. Due to the cancellation, the PA may work with a lower power supply voltage and conserve power, without entering the NL region.

Advanced handling of the NL distortion may involve estimating and canceling the NL influence to eliminate the NL impairment limitation. With the aid of the cancellation, a network entity (e.g., gNB) can work at an operation point in the NL region without the concern of having an NL limiting noise floor. However, the NL cancellation benefits come at the expense of greatly increasing the complexity and the overall latency of the data decoding process at the UE. In fact, the demanded complexity and latency increases as the NL distortion becomes more severe, which occurs as the transmission power increases and the power supply voltage decreases. Hence, the amount that the transmission power increases and the power supply voltage decreases may depend on the UE's power consumption capability and the DL latency limitations.

As indicated above, FIG. 5 is provided as an example. Other examples may differ from what is described with regard to FIG. 5.

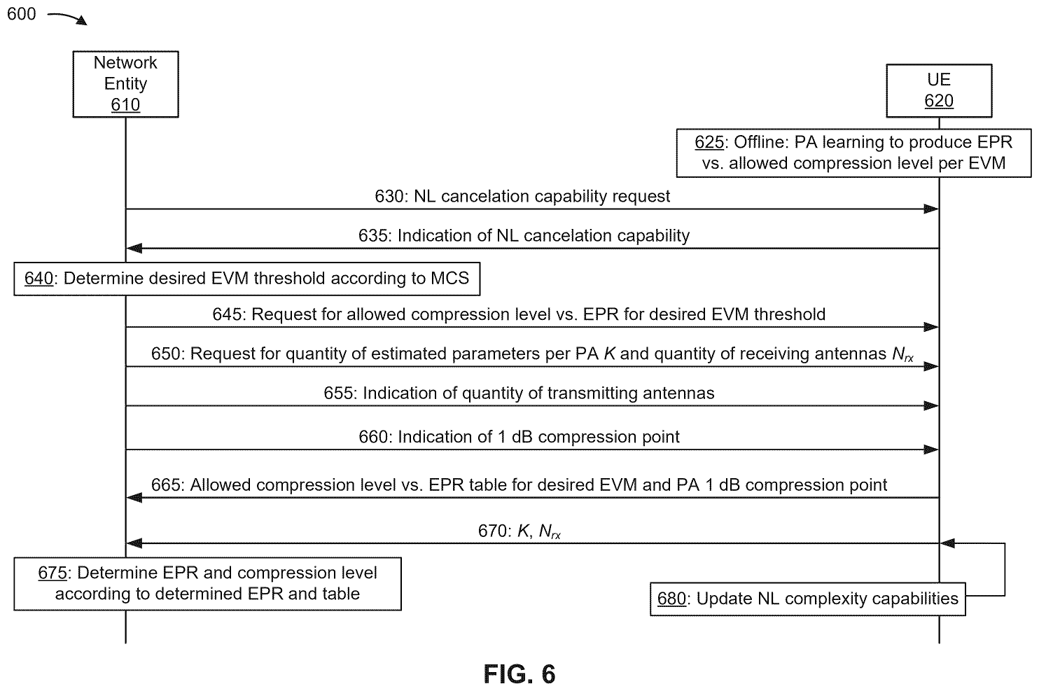

FIG. 6 is a diagram illustrating an example 600 associated with canceling NL distortion, in accordance with the present disclosure. As shown in FIG. 6, a network entity 610 (e.g., a network node 110) and a UE 620 (e.g., a UE 120) may communicate with one another via a wireless network (e.g., wireless communication network 100). In example 600, the network entity 610 acts as a transmitter and the UE 620 acts as a receiver.

According to various aspects described herein, a UE may indicate its NL cancellation complexity capabilities and latency limitations, to aid a network entity (e.g., gNB) in determining an optimum transmission power for the network entity. The optimum transmission power may be based at least in part on the UE's NL cancellation capabilities. The UE may transmit NL cancellation capability information (e.g., a bit in a MAC-CE) to indicate whether the UE has a capability to cancel NL distortion. The NL cancellation method is not limited to a specific algorithm and may involve the algorithm's quantity of degrees of freedom. The NL cancellation capability information may indicate whether the UE has a capability to report the quantity K of NL model parameters that the UE can estimate in each NL estimation, according to its hardware complexity limitation and the DL latency. In some aspects, K may be the quantity of basis functions of an assumed NL model. In some aspects, K may be the quantity of different power degrees at a PA polynomial model. In some aspects, K may be the quantity of components at a neural network associated with estimating the PA model. That is, K may indicate the quantity of parameters that are to be estimated regardless of the chosen NL cancellation method. The UE may report K. In some aspects, the UE may also report a quantity of receive antennas Nᵣₓ.

The network entity may receive K and Nᵣₓ and calculate an equation to parameters ratio (EPR). The quantity of parameters that are to be estimated may be determined according to the quantity of PAs at the network entity (corresponding to the quantity of transmit (Tx) antennas Nₜₓ multiplied by the quantity of NL model parameters per PA that the UE indicated that the UE could estimate K). The quantity of equations that the UE can produce may be determined according to the quantity of receive (Rx) antennas Nᵣₓ multiplied by the quantity of subcarriers that are dedicated to pilots Np. Thus, the EPR is determined according to these four parameters and can be represented as:

$$E P R = \frac{Nrx \cdot Np}{Ntx \cdot K} .$$

The EPR determines the quality (accuracy) of the NL cancellation, which allows for transmission with deeper PA compression toward the UE's having higher EPR capability.

To connect the EPR with the allowed compression level, each UE may prepare, in advance, a table of the allowed compression level per EPR, according to its implemented NL cancellation methods and per the target EVM that the network entity requested (e.g., EVM that is measured on the signal post NL cancellation-with residual NL). The network entity may request, from the UE, a target EVM associated with the currently operated MCS.

In some aspects, the UE may prepare, offline (e.g., at the factory stage), the tables of gNB-PA-backoff versus EPR per desired EVM. Since backoff is not the only parameter that might determine the PA's behavior, the UE may consider not only the backoff, but also the network entity's PA 1 decibel (dB) compression point in the offline learning. In that case, the UE may produce the table of allowed compression (backoff) versus EPR, but for multiple values of 1 dB compression points. In other words, the UE may produce multiple tables per desired EVM (per operated MCS) corresponding to the amount of the tested 1 dB compression points.

As shown by reference number 625, offline (e.g., at a factory stage), the UE 620′s PA may learn to produce an EPR versus allowed compression level per EVM. The UE 620 may learn the allowed compression level as a function of the EPR for various values of desired EVM. The UE 620 may perform measurements for the various values. In addition, the UE 620 may test various PA 1 dB compression points per desired EVM to emulate a more accurate PA model scenario per serving network entity. From these measurements, the UE 620 may determine an allowed compression level (backoff) versus EPR table for each of the examined target EVMs. These examined target EVMs may correspond to the MCSs configured for the UE 620.

As shown by reference number 630, the network entity 610 may transmit a request for an NL cancellation capability. The network entity 610 may transmit the request via a MAC-CE at the beginning of the communication, upon attaching to a cell.

As shown by reference number 635, the UE 620 may transmit NL cancellation capability information, which may include an indication of the NL cancellation capability of the UE 620. The indication may be a single bit. The UE 620 may transmit the indication via a MAC-CE. The next steps may be performed if the UE 620 indicates that the UE 620 has an NL cancellation capability.

As shown by reference number 640, the network entity 610 may determine the desired EVM threshold, according to the MCS. The desired EVM threshold may be associated with the allowed power of the residual NL impairment after correction. The EVM is expected to be sufficiently small, for successful decoding of the operated MCS. The desired EVM may be slightly smaller than the experienced noise (which is determining the operated MCS). In this way, the residual NL (the NL impairment after correction) may not limit the noise floor. The UE 620 may determine, in advance, the EVM threshold for all of its operated MCSs or determine the EVM threshold each time that the UE 620 changes the MCS, according to its cell and system conditions. Nevertheless, the determination of the desired EVM may be based at least in part on a policy of the network entity (e.g., more, or less, conservative) and system requirements.

As shown by reference number 645, the network entity 610 may transmit a request for compression information that indicates an allowed compression level versus EPR for the desired EVM threshold. The allowed compression level versus EPR may be part of a table generated for the EVM threshold. The network entity 610 may request the table. The network entity 610 may indicate the desired EVM threshold, which may include the maximum residual NL power after correction. The network entity 610 may transmit the request in a PDCCH message when the network entity 610 changes the desired EVM threshold (e.g., MCS changed, system requirements changed). The network entity 610 may save the tables received from the UE 620 to avoid (or reduce) future requests (according to each network entity policy).

As shown by reference number 650, the network entity 610 may transmit a request for a quantity of estimated parameters (parameters that can be estimated) per PA K and the quantity of receiving antennas Nr., which may be associated with the NL complexity capability of the UE 620 and/or a calculation latency that the UE 620 can afford. The network entity 610 may transmit the request via a PDCCH message.

As shown by reference number 655, the network entity 610 may transmit an indication of the quantity of transmitting (Tx) antennas Nₜₓ of the network entity 610. This quantity may help the UE 620 to determine how many parameters the UE 620 can estimate per transmitting antenna or per PA. The network entity 610 may transmit the indication via a PDCCH message each time the network entity 610 changes the quantity of transmitting antennas.

As shown by reference number 660, the network entity 610 may transmit an indication of a 1 dB compression point. The 1 dB compression point may help the UE 620 to determine a more accurate allowed compression point versus signal-to-noise ratio (SNR) table. The network entity 610 may transmit the indication via a PDCCH message each time the network entity 610 changes its operated PA or changes the supply voltages.

As shown by reference number 665, the UE 620 may transmit compression information that includes an indication of an allowed compression level versus EPR table for a desired EVM threshold and PA 1 dB compression point. The UE 620 may select the appropriate table from stored tables according to the desired EVM threshold. The compression information may include the table (or multiple tables associated with the desired EVM threshold). The UE 620 may transmit the indication via a PUCCH message.

As shown by reference number 670, the UE 620 may transmit K and Nᵣₓ. The UE 620 may determine K (parameters that can be estimated per PA) based at least in part on the Nₜₓ, current hardware capacities, and/or system latency requirements. The UE 620 may transmit K and Nᵣₓ via a PUCCH message.

As shown by reference number 675, the network entity 610 may determine the EPR and the compression level according to the determined EPR and the table. The network entity 610 may first determine the EPR according to the EPR expression

$$E P R = \frac{Nrx \cdot Np}{Ntx \cdot K} ,$$

where Nₜₓ and Nₚ are determined from the UE 620′s own configuration. The network entity 610 may then select the compression level based at least in part on the table (allowed compression point versus EPR) indicated by the UE 620. Each network entity 610 may have more backoff (work in lower compression point which results in less severe NL distortion) compared to the indicated table, based at least in part on its own policy (e.g., more, or less, conservative). The network entity 610 and the UE 620 may keep operating in that compression point until the UE 620 changes to a new allowed compression point (due to optimal changing in one of the EPR parameters or changing of the desired EVM/operated MCS).

As shown by reference number 680, the UE 620 may transmit an update of the NL complexity capability (e.g., NL cancellation capability). The update may be due to a low battery mode. The network entity 610 may retransmit the message.

As indicated above, FIG. 6 is provided as an example. Other examples may differ from what is described with respect to FIG. 6.

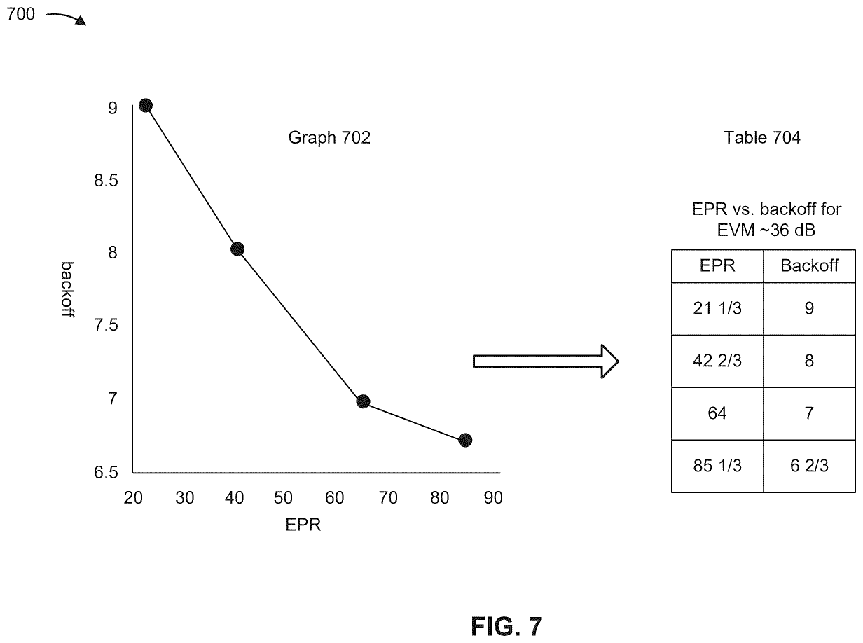

FIG. 7 is a diagram illustrating an example 700 of backoff versus EPR, in accordance with the present disclosure.

Example 700 shows a graph 702 of the allowed compression point (backoff) versus EPR for the case of desired EVM of −36 dB, according to the operated MCS of 1 K quadrature amplitude modulation (QAM). Example 700 also shows a table 704 of the EPR versus backoff.

In some aspects, a UE (e.g., UE 620) may use an NL cancellation mechanism (of type DPOD) to cancel the NL impairment. The mechanism may involve a model that approximates the PA model as a finite polynomial expression, where the quantity of different power degrees is the quantity of parameters K that are needed to be estimated.

Using that NL cancellation method, the UE may determine the allowed compression point versus EPR that yields −36 dB EVM residual NL impairment after the NL correction, which may involve an EVM between the distorted signal with the residual NL distortion and the clean signal. Each UE may produce its own tables, by testing its own NL cancellation method (i.e., not necessarily using a DPOD cancellation method).

Example 700 involves a DL communication link with the affordable backoff vs the EPR:

$$NTx = 1 ; NP = 64 ; K = 3 ; NRx = 1 \to E P R = 21.33$$

$$NTx = 1 ; NP = 64 ; K = 3 ; NRx = 2 \to E P R = 42.67$$

$$NTx = 1 ; NP = 64 ; K = 3 ; NRx = 3 \to E P R = 64$$

$$NTx = 1 ; NP = 64 ; K = 3 ; NRx = 4 \to E P R = 85.33$$

The curve may be associated with an MCS of 1K QAM and hence the desired distortion EVM (the residual NL impairment after the correction) in the MCS is expected to be less than −36 dB (according to Shannon's capacity theorem). The EVM requirement may be stricter, as the operated MCS order will be higher. N_{P}=64 refers to the number of pilots—e.g., 1 DMRS with 64 REs of allocation.

This exemplified NL cancellation method may suppress the NL distortion to an EVM of −36 dB as a function of the EPR, meaning that a high EPR (many observations to parameters ratio) can allow for more aggressive PA compression (smaller backoff). Graph 702 shows the recommended backoff (allowed compression level) for each of the described scenarios that will guarantee the operated MCS reception.

After the network entity receives the UE's parameters K and Nᵣₓ and the table of allowed backoff per EPR table, the network entity may calculate the EPR. According to the calculated EPR, the network entity may decide on the compression point (amount of backoff) based at least in part on the UE's table of allowed backoff per EPR table.

If the network entity changes the MCS during the communication, the network entity may transmit a request for an updated table that corresponds to the desired EVM according to the new MCS.

If the determined EPR is in between two values in the EPR versus backoff table, the network entity may configure the weighted average backoff. In some aspects, if the EPR=30, the configured backoff may be 8.5. When the network entity is enabled with smaller backoff, the power efficiency may improve and the transmission power may be increased, and hence the coverage is improved.

Alternatively, instead of varying the backoff, the network entity may reduce the supply voltage of its PA (depending on the EPR value), thus reducing power consumption. This will incur a less desirable EVM (before NL cancellation), but UEs having a good EPR (e.g., high EPR) may manage to further suppress this poor EVM down to the required level (e.g. −36 dB in 1024 QAM).

As indicated above, FIG. 7 is provided as an example. Other examples may differ from what is described with regard to FIG. 7.

FIG. 8 is a diagram illustrating an example process 800 performed, in some aspects, at a UE or an apparatus of a UE, in accordance with the present disclosure. Example process 800 is an example where the apparatus or the UE (e.g., UE 120, UE 620) performs operations associated with a compression level based on an NL capability.

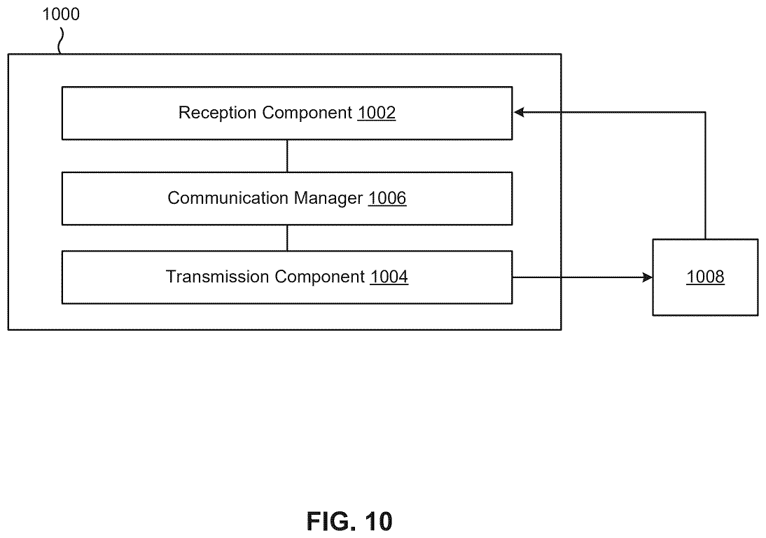

As shown in FIG. 8, in some aspects, process 800 may include transmitting NL cancellation capability information associated with the UE (block 810). In some aspects, the UE (e.g., using transmission component 1004 and/or communication manager 1006, depicted in FIG. 10) may transmit NL cancellation capability information associated with the UE, as described above.

As further shown in FIG. 8, in some aspects, process 800 may include receiving a request to indicate a quantity of parameters to estimate per PA and a quantity of receive antennas (block 820). In some aspects, the UE (e.g., using reception component 1002 and/or communication manager 1006, depicted in FIG. 10) may receive a request to indicate a quantity of parameters to estimate per PA and a quantity of receive antennas, as described above.

As further shown in FIG. 8, in some aspects, process 800 may include transmitting a report that indicates the quantity of parameters and the quantity of receive antennas (block 830). In some aspects, the UE (e.g., using transmission component 1004 and/or communication manager 1006, depicted in FIG. 10) may transmit a report that indicates the quantity of parameters and the quantity of receive antennas, as described above.

Process 800 may include additional aspects, such as any single aspect or any combination of aspects described below and/or in connection with one or more other processes described elsewhere herein.

In a first aspect, process 800 includes receiving a request for the NL cancellation capability information.

In a second aspect, alone or in combination with the first aspect, process 800 includes receiving a request for compression information that indicates one or more allowed compression levels that correspond to one or more respective EPRs for an EVM threshold, and transmitting the compression information.

In a third aspect, alone or in combination with one or more of the first and second aspects, process 800 includes receiving a communication, and canceling NL distortion of the communication based at least in part on an allowed compression level of the one or more allowed compression levels.

In a fourth aspect, alone or in combination with one or more of the first through third aspects, canceling the NL distortion includes canceling the NL distortion using a model that approximates a PA model as a finite polynomial expression, and a quantity of different power degrees corresponds to the quantity of parameters.

In a fifth aspect, alone or in combination with one or more of the first through fourth aspects, a respective EPR of the one or more respective EPRs corresponds to a ratio of (the quantity of receive antennas times a quantity of subcarriers dedicated to pilots) to (a quantity of transmit antennas of a network entity times the quantity of parameters per PA).

In a sixth aspect, alone or in combination with one or more of the first through fifth aspects, process 800 includes receiving an indication of the quantity of transmit antennas.

In a seventh aspect, alone or in combination with one or more of the first through sixth aspects, process 800 includes receiving a request for the EVM threshold, and transmitting an indication of the EVM threshold.

In an eighth aspect, alone or in combination with one or more of the first through seventh aspects, the quantity of parameters includes a quantity of basis functions of an assumed NL model.

In a ninth aspect, alone or in combination with one or more of the first through eighth aspects, the quantity of parameters includes a quantity of different power degrees at a PA polynomial.

In a tenth aspect, alone or in combination with one or more of the first through ninth aspects, the quantity of parameters includes a quantity of components at a neural network associated with estimating a PA model.

In an eleventh aspect, alone or in combination with one or more of the first through tenth aspects, process 800 includes receiving an indication of a 1 dB compression point.

In a twelfth aspect, alone or in combination with one or more of the first through eleventh aspects, process 800 includes transmitting updated NL cancellation capability information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, in some aspects, at a network entity or an apparatus of a network entity, in accordance with the present disclosure. Example process 900 is an example where the apparatus or the network entity (e.g., network node 110, network entity 610) performs operations associated with a compression level based on an NL capability.

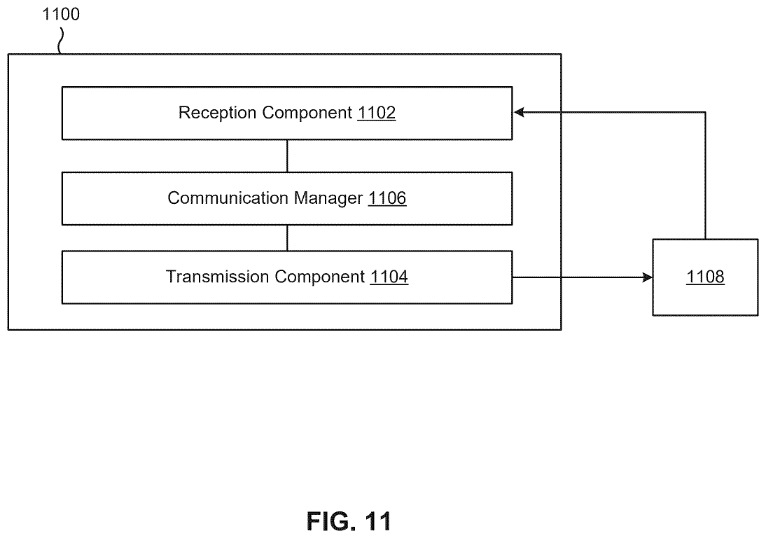

As shown in FIG. 9, in some aspects, process 900 may include receiving NL cancellation capability information associated with a UE (block 910). In some aspects, the network entity (e.g., using reception component 1102 and/or communication manager 1106, depicted in FIG. 11) may receive NL cancellation capability information associated with a UE, as described above.

As further shown in FIG. 9, in some aspects, process 900 may include transmitting, based at least in part on the NL cancellation capability information, a request to indicate a quantity of parameters to estimate per PA and a quantity of receive antennas (block 920). In some aspects, the network entity (e.g., using transmission component 1104 and/or communication manager 1106, depicted in FIG. 11) may transmit, based at least in part on the NL cancellation capability information, a request to indicate a quantity of parameters to estimate per PA and a quantity of receive antennas, as described above.

As further shown in FIG. 9, in some aspects, process 900 may include receiving a report that indicates the quantity of parameters and the quantity of receive antennas (block 930). In some aspects, the network entity (e.g., using reception component 1102 and/or communication manager 1106, depicted in FIG. 11) may receive a report that indicates the quantity of parameters and the quantity of receive antennas, as described above.

Process 900 may include additional aspects, such as any single aspect or any combination of aspects described below and/or in connection with one or more other processes described elsewhere herein.

In a first aspect, process 900 includes transmitting a request for compression information that indicates one or more allowed compression levels that correspond to one or more respective EPRs for an EVM threshold, and receiving the compression information.

In a second aspect, alone or in combination with the first aspect, process 900 includes receiving a request for the EVM threshold, and transmitting an indication of the EVM threshold.

In a third aspect, alone or in combination with one or more of the first and second aspects, process 900 includes calculating an EPR based at least in part on a ratio of (the quantity of receive antennas times a quantity of subcarriers dedicated to pilots) to (a quantity of transmit antennas of the network entity times the quantity of parameters per PA), and selecting an allowed compression level from the compression information that corresponds to the calculated EPR.

In a fourth aspect, alone or in combination with one or more of the first through third aspects, process 900 includes transmitting a communication based at least in part on the allowed compression level.

In a fifth aspect, alone or in combination with one or more of the first through fourth aspects, process 900 includes receiving an indication of a 1 dB compression point.

In a sixth aspect, alone or in combination with one or more of the first through fifth aspects, process 900 includes receiving updated NL capability information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (in some aspects, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other aspects), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other aspects), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. In some aspects, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit NL cancellation capability information associated with the UE. The reception component 1002 may receive a request to indicate a quantity of parameters to estimate per PA and a quantity of receive antennas. The transmission component 1004 may transmit a report that indicates the quantity of parameters and the quantity of receive antennas.

The reception component 1002 may receive a request for the NL cancellation capability information. The reception component 1002 may receive a request for compression information that indicates one or more allowed compression levels that correspond to one or more respective EPRs for an EVM threshold. The transmission component 1004 may transmit the compression information. The reception component 1002 may receive a communication.

The communication manager 1006 may cancel NL distortion of the communication based at least in part on an allowed compression level of the one or more allowed compression levels. The reception component 1002 may receive an indication of the quantity of transmit antennas. The reception component 1002 may receive a request for the EVM threshold.

The transmission component 1004 may transmit an indication of the EVM threshold. The reception component 1002 may receive an indication of a 1 decibel compression point. The transmission component 1004 may transmit updated NL cancellation capability information.

The number and arrangement of components shown in FIG. 10 are provided as an aspect. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity, or a network entity may include the apparatus 1100. In some aspects, the apparatus 1100 includes a reception component 1102, a transmission component 1104, and/or a communication manager 1106, which may be in communication with one another (in some aspects, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other aspects), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to- analog conversion, multiplexing, interleaving, mapping, or encoding, among other aspects), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1104 may be co-located with the reception component 1102 in one or more transceivers.

The communication manager 1106 may support operations of the reception component 1102 and/or the transmission component 1104. In some aspects, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive NL cancellation capability information associated with a UE. The transmission component 1104 may transmit, based at least in part on the NL cancellation capability information, a request to indicate a quantity of parameters to estimate per PA and a quantity of receive antennas. The reception component 1102 may receive a report that indicates the quantity of parameters and the quantity of receive antennas.

The transmission component 1104 may transmit a request for compression information that indicates one or more allowed compression levels that correspond to one or more respective EPRs for an EVM threshold.

The reception component 1102 may receive the compression information. The reception component 1102 may receive a request for the EVM threshold. The transmission component 1104 may transmit an indication of the EVM threshold.

The communication manager 1106 may calculate an EPR based at least in part on a ratio of (the quantity of receive antennas times a quantity of subcarriers dedicated to pilots) to (a quantity of transmit antennas of the network entity times the quantity of parameters per PA). The communication manager 1106 may select an allowed compression level from the compression information that corresponds to the calculated EPR. The transmission component 1104 may transmit a communication based at least in part on the allowed compression level.

The reception component 1102 may receive an indication of a 1 dB compression point. The reception component 1102 may receive updated NL capability information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting nonlinearity (NL) cancellation capability information associated with the UE; receiving a request to indicate a quantity of parameters to estimate per power amplifier (PA) and a quantity of receive antennas; and transmitting a report that indicates the quantity of parameters and the quantity of receive antennas.

Aspect 2: The method of Aspect 1, further comprising receiving a request for the NL cancellation capability information.

Aspect 3: The method of any of Aspects 1-2, further comprising: receiving a request for compression information that indicates one or more allowed compression levels that correspond to one or more respective equation to parameters ratios (EPRs) for an error vector magnitude (EVM) threshold; and transmitting the compression information.

Aspect 4: The method of Aspect 3, further comprising: receiving a communication; and canceling NL distortion of the communication based at least in part on an allowed compression level of the one or more allowed compression levels.

Aspect 5: The method of Aspect 4, wherein canceling the NL distortion includes canceling the NL distortion using a model that approximates a PA model as a finite polynomial expression, and wherein a quantity of different power degrees corresponds to the quantity of parameters.

Aspect 6: The method of Aspect 3, wherein a respective EPR of the one or more respective EPRs corresponds to a ratio of (the quantity of receive antennas times a quantity of subcarriers dedicated to pilots) to (a quantity of transmit antennas of a network entity times the quantity of parameters per PA).

Aspect 7: The method of Aspect 6, further comprising receiving an indication of the quantity of transmit antennas.

Aspect 8: The method of Aspect 3, further comprising: receiving a request for the EVM threshold; and transmitting an indication of the EVM threshold.

Aspect 9: The method of any of Aspects 1-8, wherein the quantity of parameters includes a quantity of basis functions of an assumed NL model.

Aspect 10: The method of any of Aspects 1-9, wherein the quantity of parameters includes a quantity of different power degrees at a PA polynomial.

Aspect 11: The method of any of Aspects 1-10, wherein the quantity of parameters includes a quantity of components at a neural network associated with estimating a PA model.

Aspect 12: The method of any of Aspects 1-11, further comprising receiving an indication of a 1 decibel compression point.

Aspect 13: The method of any of Aspects 1-12, further comprising transmitting updated NL cancellation capability information.

Aspect 14: A method of wireless communication performed by a network entity, comprising: receiving nonlinearity (NL) cancellation capability information associated with a user equipment (UE); transmitting, based at least in part on the NL cancellation capability information, a request to indicate a quantity of parameters to estimate per power amplifier (PA) and a quantity of receive antennas; and receiving a report that indicates the quantity of parameters and the quantity of receive antennas.

Aspect 15: The method of Aspect 14, further comprising: transmitting a request for compression information that indicates one or more allowed compression levels that correspond to one or more respective equation to parameters ratios (EPRs) for an error vector magnitude (EVM) threshold; and receiving the compression information.

Aspect 16: The method of Aspect 15, further comprising: receiving a request for the EVM threshold; and transmitting an indication of the EVM threshold.

Aspect 17: The method of Aspect 15, further comprising: calculating an EPR based at least in part on a ratio of (the quantity of receive antennas times a quantity of subcarriers dedicated to pilots) to (a quantity of transmit antennas of the network entity times the quantity of parameters per PA); and selecting an allowed compression level from the compression information that corresponds to the calculated EPR.

Aspect 18: The method of Aspect 17, further comprising transmitting a communication based at least in part on the allowed compression level.

Aspect 19: The method of any of Aspects 14-18, further comprising receiving an indication of a 1 decibel compression point.

Aspect 20: The method of any of Aspects 14-19, further comprising receiving updated NL capability information.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other aspects, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other aspects.

As used herein, a phrase referring to “at least one of” a list of items refers to any combination of those items, including single members. As an aspect, “at least one of: a, b, or c” is intended to cover a, b, c, a+b, a+c, b+c, and a+b+c, as well as any combination with multiples of the same element (in some aspects, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (in some aspects, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (in some aspects, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

1. An apparatus for wireless communication at a user equipment (UE), comprising:
one or more memories; and
one or more processors, coupled to the one or more memories, individually or collectively configured to cause the UE to:
transmit nonlinearity (NL) cancellation capability information associated with the UE, wherein the NL cancellation capability information indicates whether the UE has a capability to cancel NL distortion;
receive a request to indicate a quantity of parameters to estimate per power amplifier (PA) and a quantity of receive antennas; and
transmit a report that indicates the quantity of parameters and the quantity of receive antennas.

2. The apparatus of claim 1,
wherein the one or more processors are individually or collectively configured to cause the UE to receive a request for the NL cancellation capability information.

3. The apparatus of claim 1,
wherein the one or more processors are individually or collectively configured to cause the UE to:
receive a request for compression information that indicates one or more allowed compression levels that correspond to one or more respective equation to parameters ratios (EPRs) for an error vector magnitude (EVM) threshold; and
transmit the compression information.

4. The apparatus of claim 3,
wherein the one or more processors are individually or collectively configured to cause the UE to:
receive a communication; and
cancel NL distortion of the communication based at least in part on an allowed compression level of the one or more allowed compression levels.

5. The apparatus of claim 4,
wherein canceling the NL distortion includes canceling the NL distortion using a model that approximates a PA model as a finite polynomial expression, and wherein a quantity of different power degrees corresponds to the quantity of parameters.

6. The apparatus of claim 3,
wherein a respective EPR of the one or more respective EPRs corresponds to a ratio of (the quantity of receive antennas times a quantity of subcarriers dedicated to pilots) to (a quantity of transmit antennas of a network entity times the quantity of parameters per PA).

7. The apparatus of claim 6,
wherein the one or more processors are individually or collectively configured to cause the UE to receive an indication of the quantity of transmit antennas.

8. The apparatus of claim 3,
wherein the one or more processors are individually or collectively configured to cause the UE to:
receive a request for the EVM threshold; and
transmit an indication of the EVM threshold.

9. The apparatus of claim 1,
wherein the quantity of parameters includes a quantity of basis functions of an assumed NL model.

10. The apparatus of claim 1,
wherein the quantity of parameters includes a quantity of different power degrees at a PA polynomial.

11. The apparatus of claim 1,
wherein the quantity of parameters includes a quantity of components at a neural network associated with estimating a PA model.

12. The apparatus of claim 1,
wherein the one or more processors are individually or collectively configured to cause the UE to receive an indication of a 1 decibel compression point.

13. The apparatus of claim 1,
wherein the one or more processors are individually or collectively configured to cause the UE to transmit updated NL cancellation capability information.

14. An apparatus for wireless communication at a network entity, comprising:
one or more memories; and
one or more processors, coupled to the one or more memories, individually or collectively configured to cause the network entity to:
receive nonlinearity (NL) cancellation capability information associated with a user equipment (UE), wherein the NL cancellation capability information indicates whether the UE has a capability to cancel NL distortion;
transmit, based at least in part on the NL cancellation capability information, a request to indicate a quantity of parameters to estimate per power amplifier (PA) and a quantity of receive antennas; and
receive a report that indicates the quantity of parameters and the quantity of receive antennas.

15. The apparatus of claim 14,
wherein the one or more processors are individually or collectively configured to cause the network entity to:
transmit a request for compression information that indicates one or more allowed compression levels that correspond to one or more respective equation to parameters ratios (EPRs) for an error vector magnitude (EVM) threshold; and
receive the compression information.

16. The apparatus of claim 15,
wherein the one or more processors are individually or collectively configured to cause the network entity to:
receive a request for the EVM threshold; and
transmit an indication of the EVM threshold.

17. The apparatus of claim 15,
wherein the one or more processors are individually or collectively configured to cause the network entity to:
calculate an EPR based at least in part on a ratio of (the quantity of receive antennas times a quantity of subcarriers dedicated to pilots) to (a quantity of transmit antennas of the network entity times the quantity of parameters per PA); and
select an allowed compression level from the compression information that corresponds to the calculated EPR.

18. The apparatus of claim 17,
wherein the one or more processors are individually or collectively configured to cause the network entity to transmit a communication based at least in part on the allowed compression level.

19. The apparatus of claim 14,
wherein the one or more processors are individually or collectively configured to cause the network entity to receive updated NL capability information.

20. A method of wireless communication performed by a user equipment (UE), comprising:
transmitting nonlinearity (NL) cancellation capability information associated with the UE, wherein the NL cancellation capability information indicates whether the UE has a capability to cancel NL distortion;
receiving a request to indicate a quantity of parameters to estimate per power amplifier (PA) and a quantity of receive antennas; and
transmitting a report that indicates the quantity of parameters and the quantity of receive antennas.
